(19) United States
(12) Patent Application Publication
(10) Pub. No.: US 2003/0221529 A1
(43) Pub. Date: Dec. 4, 2003

(54) Adjustable board stop

(76) Inventor: Perry E. Smith, Kennewick, WA (US)

Correspondence Address: Floyd E. Ivey, Liebler, Ivey & Connor, P.O. Box 6125, Kennewick, WA, 99336, US

(21) Appl. No.: 10/159,263

(22) Filed: May 28, 2002

(51) Int. Cl. B26D 7/06

(52) U.S. Cl. 83/438; 83/471.2

(57) ABSTRACT

An adjustable board stop made from a U-shaped bracket attached to an extension that supports a hinge and hinge pin attached to an L-shaped bracket that protrudes out over the middle section of the top surface of the U-shaped bracket and perpendicular down from the hinge pin adjacent to the U-shaped bracket. Using manuel or a mechanical means the L-shaped bracket that protrudes over the U-shaped bracket is lifted and pivoted so that the L-shaped bracket on the hinge clasps a rail in between the perpendicular end of the L-shaped bracket and the U-shaped bracket. This fixed pressure holds the adjustable board stop fast in place for use in board sawing.

### BACKGROUND OF THE INVENTION

1. Field of the Invention

The present invention relates generally to attachments to table saws, and more particularly, but not necessarily entirely, to an adjustable board stop, typically attached to a longitudinal rail on a table saw.

2. Description of Related Art

Table saws are well known in the private and commercial wood working industry. Table saws are designed for cutting various sides and shapes of boards.

The precision cutting of any board on a table saw is predicted upon the ability of the operator to hold the board in a fixed position throughout the sawing process.

Attempts have been made in the prior art to provide a means to hold the board while the sawing is in progress. U.S. Pat. No. 2,731,989 (issued Jan. 24, 1956 to Valcourt and Huff) discloses a cross cutting table saw gage attachment. The attachment is costly and difficult to manufacture; it has multiple working components that may wear and require replacement. Furthermore, the attachment had no mechanism to allow the L-shaped plate angles to expand when the attachment was opened and the entire pressure of the apparatus against the abutment was born by the small flanged portion of the rod. This focused torque and pressure would tend to wear a crescent shaped groove into the L-shaped plate angles and require replacements of the flanged portion of the rod. Also as the groove wears into the L-shaped plate angels the pressure that can be applied to the L-shaped plate angles is decreased requiring the L-shaped plate angle to be replaced or a new table saw gage attachment to be purchased.

The present invention minimizes and in some aspects eliminates several of the disadvantages of the related art. The present invention is simple in design and manufacture and provides a much broader area for the dispersal and application of the pressure than a small flanged portion of the rod.

### SUMMARY OF THE INVENTION

The present invention is directed to a removable mass holder. In one embodiment the holder, is placed against a fixed object, which has a first side and a second side. The holder is connected to a lever with a horizontal arm and a vertical arm, and a fulcrum is also attached to the holder, so that when the horizontal arm of the lever is manually pivoted in an upward direction against the fulcrum the vertical arm is pressed against the fixed object first side, pulling the holder to the fixed object second side to secure the holder onto the fixed object.

In one aspect, the present invention is directed to an adjustable board stop. In one embodiment, the adjustable board stop comprises, an adjustable metal stop having an outer surface attached to a substantially U-shaped bracket with two extensions. Each of the two substantially U-shaped bracket extensions have at least one aperture. A pin is inserted in the at least one aperture of the two substantially U-shaped bracket extensions so that the pin is positioned over an L-shaped bracket having a lower end and an upper end. The L-shaped bracket lower end positioned perpendicular to the outer surface of the metal stop and the L-shaped bracket upper end positioned parallel onto the outer surface of the metal stop. The L-shaped bracket upper end has a mechanism for lifting the L-shaped bracket upper end and for closing the L-shaped bracket lower end on a first side of a fixed rail to draw the adjustable metal stop to a second side of the fixed rail. The adjustable metal stop is adjustable along a longitudinal direction of the fixed rail, for abutting wooden board against the adjustable metal stop so that the board can be held fast against the force and vibration of the saw blade and accurately cut.

### BRIEF DESCRIPTION OF THE DRAWINGS

FIG. 1 is a perspective of an adjustable board stop holding a board for sawing by a radial arm saw.

FIG. 2 is a perspective view of a wooden board abutted against an adjustable board stop on a table saw with a miter gauge.

FIG. 3 is the front end view of the adjustable board stop clasping the rail on a table saw.

FIG. 4 is the left end view of FIG. 3.

FIG. 5 is the right end view of FIG. 3.

FIG. 6 is the vertical view of the top of the adjustable board stop clamped to a table saw rail.

FIG. 7 is a vertical view of the bottom of the adjustable board stop clamped to a table saw rail.

FIG. 8 is an exploded view of the parts to an adjustable board stop prior to assembly.

FIG. 9 is a top angular view of an assembled adjustable board stop.

FIG. 10 is a view of an assembled board stop from a bottom angle showing the roughened surface of the second L-shaped bracket first perpendicular end.

FIG. 11 is an exploded view of an embodiment of the adjustable board stop.

### DETAILED DESCRIPTION OF THE PREFERRED EMBODIMENTS

For the purposes of promoting an understanding of the principles in accordance with the invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

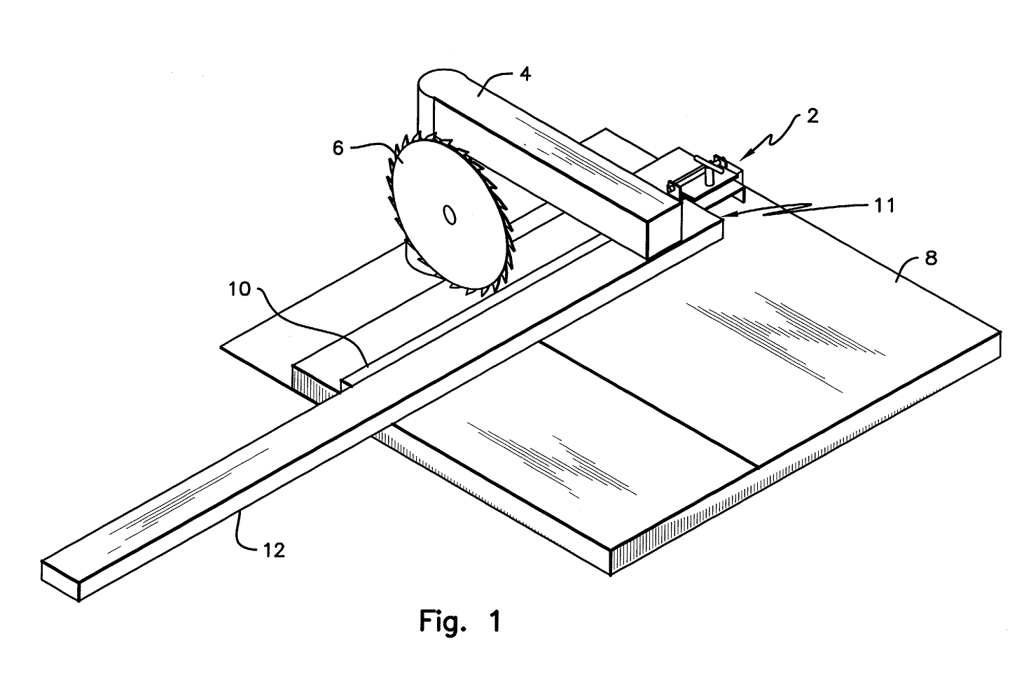

Referring now to FIG. 1, the adjustable board stop 2 is shown clamped to a rail 10 and holding or preventing the distal end 11 of the wooden board 12 from movement on the table 8 while the saw blade 6 on the radial arm saw 4 is used to cut or saw the wooden board 12. The adjustable board stop 2 may be considered a removable mass holder for any and all types of masses that may not be wooden or have the shape of a board 12.

The adjustable board stop 2 may be composed of any type of rigid material that can withstand pressure. The rigid material is typically a metal such as iron or aluminum or an any alloy such as steel. The rigid material may also include plastics and ceramics. The individual parts of the board stop 2 may be made of a variety of materials so long as each part is made of material that can withstand the stress and strain applied specifically to the individual part.

The rail 10 may also be any fixed object placed in any horizontal or vertical direction and with any shape that will allow a mass holder to be positioned anywhere along the fixed object. The rail shape is preferably rectangular with a top and two sides.

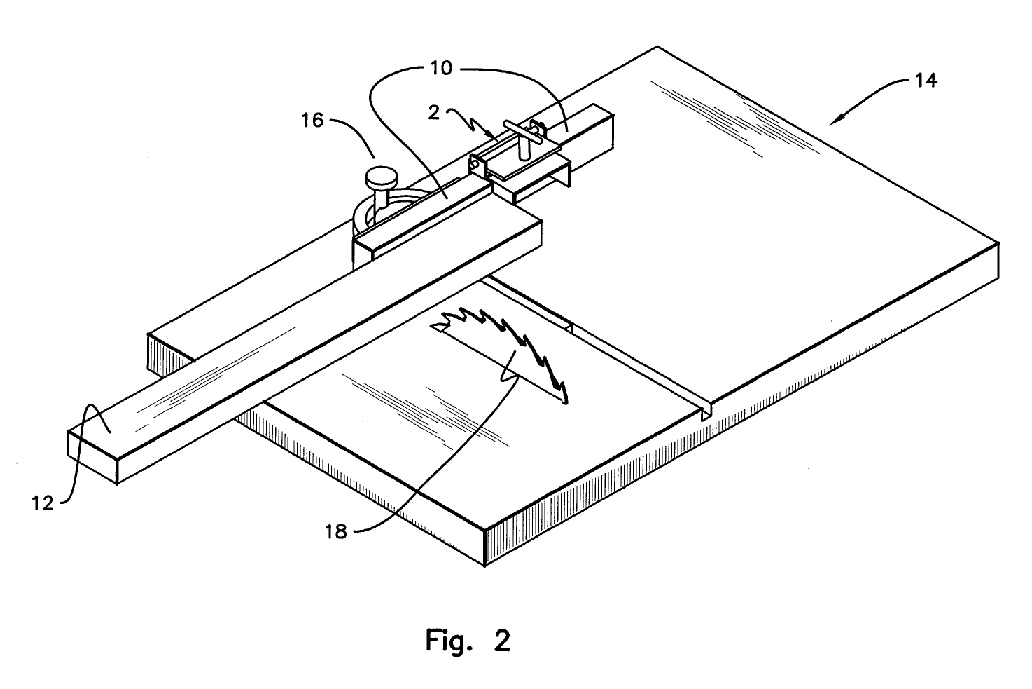

FIG. 2 shows a perspective view of the adjustable board stop 2 pinching a rail 10 of a table saw 14 having a miter gauge 16. The wooden board 12 is abutted or pressed against the adjustable board stop 2 for precision sawing by the table saw blade 18.

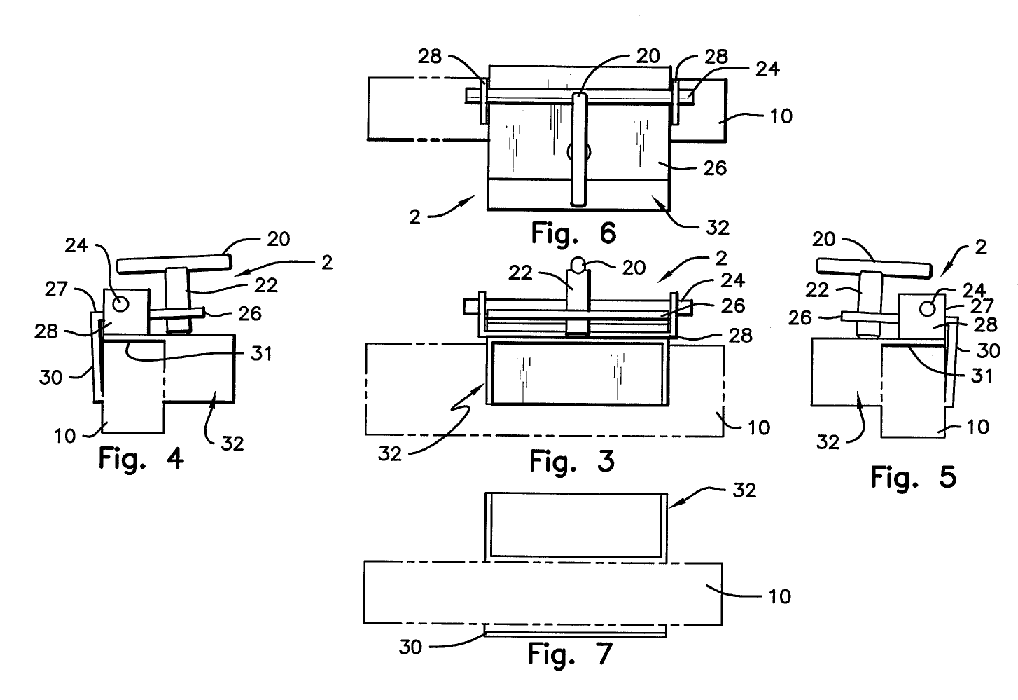

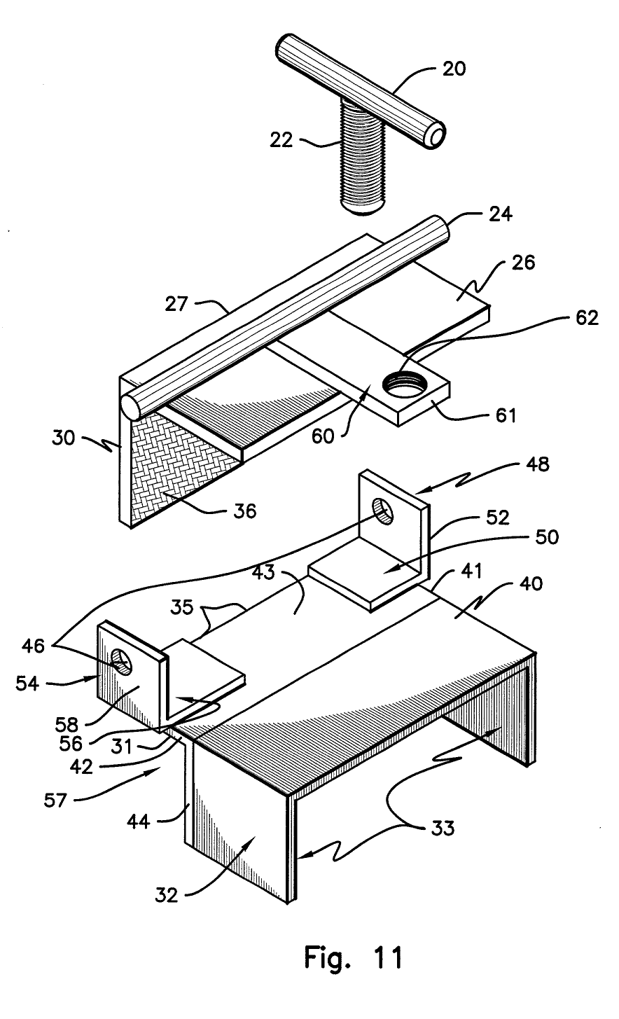

In FIG. 3 the front view of the adjustable board stop 2 represents the first substantially U-shaped bracket 32 touching the fixed rail 10 and the adjustable board stop 2 in position for clamping onto the fixed rail 10. The hinge or second substantially U-shaped bracket 28 along with the front edge 35 (FIG. 11) of the second L-shaped bracket second perpendicular end 26 can be seen.

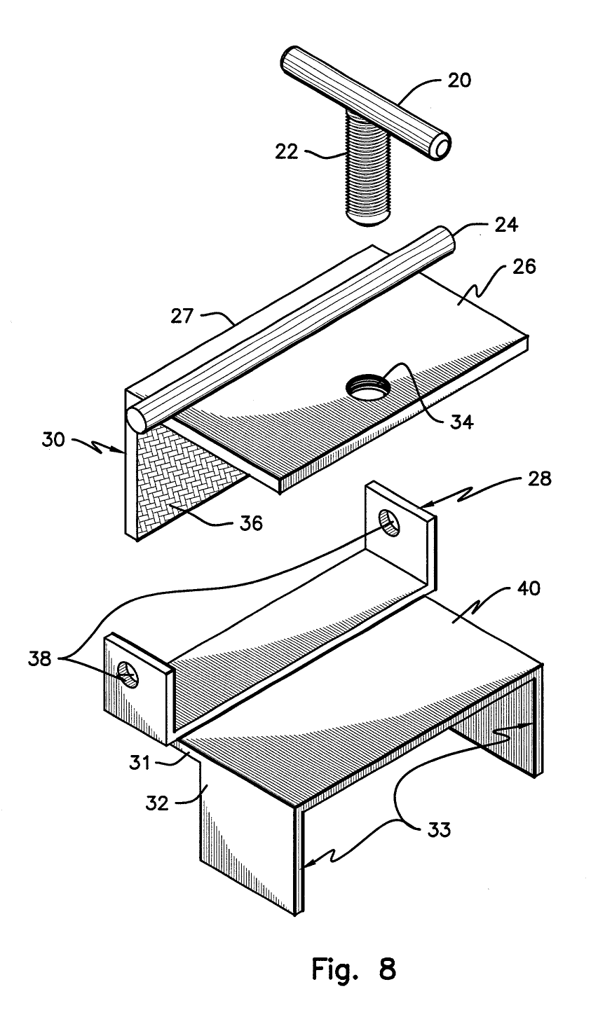

FIG. 3 also shows a hinge pin 24 or fulcrum, inserted into the second substantially U-shaped bracket 28, a handle 20 and a threaded shaft 22 threaded through the second L-shaped bracket second perpendicular end 26 onto the top surface 40 (FIG. 8) of the first substantially U-shaped bracket 32 as the threaded shaft 22 lifts the second L-shaped bracket second perpendicular end 26.

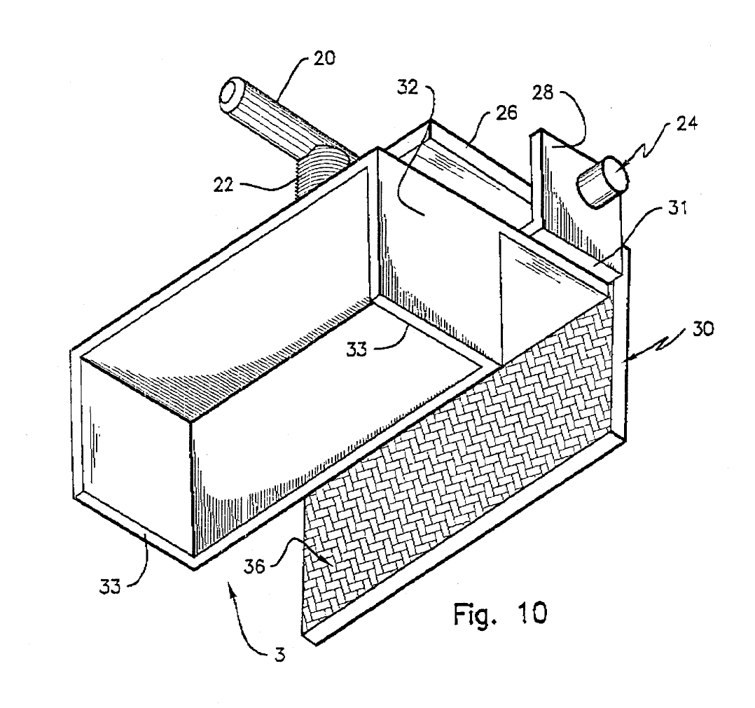

FIGS. 4 and 5 represent the left end and the right end respectively of the adjustable board stop 2. In both FIGS. 4 and 5 the second L-shaped bracket first perpendicular end 30 is parallel with first L-shaped bracket first end 44 (FIG. 10). Specifically, the second L-shaped bracket 27 second perpendicular end 26 is shown protruding beyond the top surface of the second end of the first L-shaped bracket second end 31 and the middle of the top surface 40 of the first substantially U-shaped bracket 32.

The extension or protrusion of the second L-shaped bracket second perpendicular end 26 over the first substantially U-shaped bracket 32 can be easily seen in FIG. 6.

FIG. 7 represents an upward view from underneath the second L-shaped bracket first perpendicular end 30 and the first substantially U-shaped bracket 32 as both the second L-shaped bracket first perpendicular end 30 and the first substantially U-shaped bracket 32 overhang or straddle the fixed rail 10.

FIG. 8 is an expanded or exploded view of the adjustable board stop 2 prior to assembly. FIG. 8 shows that the first L-shaped bracket second end 31 is attached or welded to the first substantially U-shaped bracket extensions 33 of equal length. The length of these two extensions 33, may vary so long as they remain equal, is typically a length of one and one half inches.

The second L-shaped bracket second perpendicular end 26 forms an extension of the top or outer surface 40 of the first substantially U-shaped bracket 32. The second U-shaped bracket 28 is attached with its outer portion against the end or furthermost edge 35 (FIG. 11) of the first L-shaped bracket second end 31.

It should be noted that the second L-shaped bracket second perpendicular end 26 is placed inside the second substantially U-shaped bracket 28, therefore the second substantially U-shaped bracket 28 must be sufficiently wide to accept the second L-shaped bracket second perpendicular end 26. FIG. 8 represents a second U-shaped bracket 28 that is slightly longer or wider so that it can accommodate the first L-shaped bracket second end 31.

The second L-shaped bracket second perpendicular end 26 has a threaded hole 34 with threads cut corresponding to the threaded shaft 22. The second L-shaped bracket first perpendicular end 30 has a roughened inside surface 36. This inside surface 36 may be prepared with rubber, a course grid, or any substance or coating designed to reduce the slippage or increase the friction between the second L-shaped bracket first perpendicular end 30 and the rail 10 (FIG. 7). In order to assemble the adjustable board stop 2, the second L-shaped bracket 27 is placed within the second U-shaped bracket 28; the hinge pin 24 is inserted into the second U-shaped bracket apertures 38 and the threaded shaft 22 is threaded into the second L-shaped bracket second perpendicular end threaded hole 34.

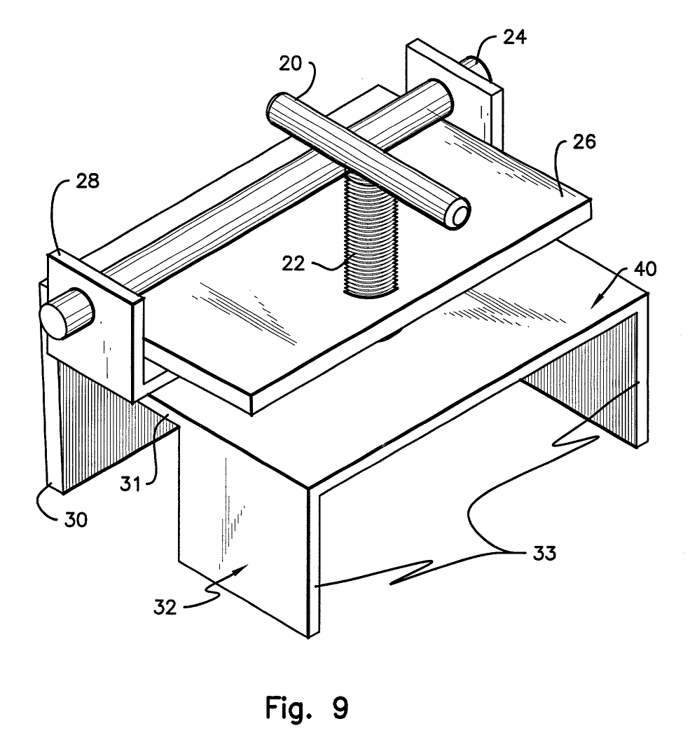

In FIG. 9 the adjustable board stop 2 is represented in an assembled or operational condition absent the fixed rail 10 being shown.

It should be noted that the length of the second L-shaped bracket second perpendicular end 26 may vary along with the position of the threaded hole 34 in the second L-shaped bracket second perpendicular end 26.

In the preferred embodiment, the second L-shaped bracket second perpendicular end 26 is extended beyond the middle portion of the top or outer surface 40 of the first substantially U-shaped bracket 32 so that the threaded hole 34 in the second L-shaped bracket second perpendicular end 26 is approximately above the middle or center portion of the top surface 40 of the first substantially U-shaped bracket 32.

FIG. 10 is the same assembly of the adjustable metal stop 2 in FIG. 9 except for the direction of the view showing the bottom side 3 or underneath of the adjustable metal stop 2.

In an alternative embodiment, FIG. 11, a first L-shaped bracket 57 having a first L-shaped bracket second end 31 of one and one half inches and a first L-shaped bracket first end 44 of one and one half inches is attached to the first U-shaped bracket 32.

The first L-shaped bracket 57 has a top or outermost side 43 to which a first L-shaped brace 48 is attached slightly beyond the right edge 41 of the first L-shaped bracket 57. The first L-shaped brace 48 has a one inch vertical end 52 and a one inch horizontal end 50. The first L-shaped brace 48 is welded to fit evenly with the edge 35 of the first L-shaped bracket second end 31. The second L-shaped brace 54 has a one inch vertical end 58 and a one inch horizontal end 56. The second L-shaped brace 54 is attached slightly beyond the left edge 42 of the first L-shaped bracket 57 to make the distance between the first L-shaped brace 48 and the second L-shaped brace 54 sufficient to permit the first L-shaped bracket second end to fit between the first L-shaped brace 48 and the second L-shaped brace 54. The second L-shaped brace 54 is welded to fit evenly with the edge 35 of the first L-shaped bracket second end 31. The first L-shaped brace vertical end 52 and the second L-shaped brace vertical end 58 both have at least one hinge pin aperture 46.

Also, in the alternative embodiment, FIG. 11, the second L-shaped bracket 27 has a first perpendicular end 30 of one and one half inches and a second perpendicular end 26 of one and one half inches. The second L-shaped bracket 27 is welded to the hinge pin 24. The second L-shaped bracket second perpendicular end 26 is then extended over the top 40 of the first substantially U-shaped bracket 32 with a flat bar 60 having a threaded aperture 62 at about the distal end 61 of the flat bar 60. This flat bar 60 allows the threaded shaft 22 to be extended or placed over a middle portion of the top surface 40 of the first U-shaped bracket 32.

In any of the forestated embodiments the assembling may be performed in a wide variety of methods not limited to: welding, cementing, glueing, soldering, or molding. Also in any of the aforementioned embodiments the second L-shaped bracket second perpendicular end 26 may be raised and lowered through any variety of mechanisms or devices. Instead of the use of a handle 20 and a threaded shaft 22 that must be manually manipulated to raise the second L-shaped bracket second perpendicular end 26; the second L-shaped bracket second perpendicular end 26 may be raised in a number of ways including: 1) manually and held with one's fingers or with a wedge, 2) any number of mechanical devices operating upon the principal of a complex lever using a rachet mechanism with a release, 3) any number of pneumatic or hydraulic devices, and 4) any operable configuration of electric motors or devices.

In view of the foregoing, it will be appreciated that the present invention provides an adjustable board stop 2 that is simple in design and manufacture and capable of being installed, adjusted and removed on any table saw as desired. The adjustable board stop 2 is easy to install and capable of withstanding significant forces.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made without departing from the principles and concepts set forth herein.

I claim:

1. A removable mass holder, comprising:
a holder placed against a fixed object, the fixed object having a first side and a second side, the holder is connected to a lever with a horizontal arm and a vertical arm; and
a fulcrum attached to the holder, the fulcrum positioned above the horizontal arm of the lever, wherein the horizontal arm of the lever is manually pivoted in an upward direction against the fulcrum and presses the vertical arm against the fixed object first side and pulls the holder to the fixed object second side to secure the holder onto the fixed object.

2. The removable mass holder according to claim 1, wherein the lever vertical arm has a roughened surface.

3. An adjustable board stop, comprising:
an adjustable metal stop having a first substantially U-shaped bracket with two extensions and a top surface;
the adjustable metal stop having a second substantially U-shaped bracket with two extensions each extension having at least one aperture;
a pin inserted into the at least one aperture of the second substantially U-shaped bracket extensions;
the pin positioned over an L-shaped bracket having a lower end and an upper end, the L-shaped bracket lower end positioned perpendicular to the top surface of the first substantially U-shaped bracket and the L-shaped bracket upper end positioned parallel onto the top surface of the first substantially U-shaped bracket; and
the L-shaped bracket upper end having a mechanism for lifting the L-shaped bracket upper end and for closing the L-shaped bracket lower end on a first side of a fixed rail and drawing the adjustable metal stop to a second side of the fixed rail, wherein the adjustable metal stop is adjustable along a longitudinal direction of the fixed rail, further wherein a wooden board is abutted against the adjustable metal stop and cut.

4. The adjustable board stop according to claim 3, wherein the L-shaped bracket lower end has an abrasive surface adjacent to the fixed rail.

5. The adjustable board stop according to claim 3, wherein the mechanism for lifting the L-shaped bracket upper end is controlled by an electric motor.

6. A moveable iron stop, comprising:
a substantially U-shaped bracket having a side edge, a top surface the top surface having a middle portion, and the substantially U-shaped bracket having two extensions of equal length;
a first L-shaped bracket having a first end and a second end, the first L-shaped bracket first end and the first L-shaped bracket second end being of equal length;
the first L-shaped bracket first end is welded to the side edge of the substantially U-shaped bracket;
the first L-shaped bracket second end having an outer edge forming an extension of the top surface of the substantially U-shaped bracket;
a first L-shaped brace having a horizontal end and a vertical end with the first L-shaped brace vertical end having an aperture;
a second L-shaped brace having a horizontal end and a vertical end with the second L-shaped brace vertical end having an aperture;
the first L-shaped brace horizontal end and the second L-shaped brace horizontal end both aligned and attached at an even and an opposite position along the outer edge of the first L-shaped bracket second end extension;
a second L-shaped bracket having a first perpendicular end and a second perpendicular end, the second L-shaped bracket first perpendicular end and the second L-shaped bracket second perpendicular end having equal lengths, the second L-shaped bracket first perpendicular end being parallel with the first L-shaped bracket first end, the second L-shaped bracket second perpendicular end placed between the first L-shaped brace vertical end and the second L-shaped brace vertical end;
a hinge pin inserted into the first L-shaped brace vertical end aperture and the second L-shaped brace vertical end aperture and the hinge pin is welded to the second L-shaped bracket second perpendicular end;
the hinge pin welded to a flat bar extending from the hinge pin to the middle portion of the top surface of the substantially U-shaped bracket;
the flat bar having a threaded hole positioned over the middle portion of the top surface of the substantially U-shaped bracket; and
a threaded shaft having a head attached to a handle, wherein manually turning of the threaded shaft through the flat bar threaded hole causes the flat bar and the second L-shaped bracket second perpendicular end to rotate the hinge pin and the second L-shaped bracket first perpendicular end to pinch a fixed rail between the second L-shaped bracket first perpendicular end and the first L-shaped bracket first end, further wherein a distal end of a wooden board to be sawed is abutted against one of the two substantially U-shaped bracket extensions, to prevent the wooden board from sliding and to allow a precision cut.

7. The moveable iron stop according to claim 6, wherein the moveable iron stop is attached to a radial arm saw table.

8. The moveable iron stop according to claim 6, wherein the moveable iron stop is attached to a table having a table saw and a miter gauge.

9. The moveable iron stop according to claim 6, wherein the second L-shaped bracket first perpendicular end has a rubber surface adjacent to the fixed table rail.

10. The moveable iron stop according to claim 6, wherein the second L-shaped bracket first perpendicular end has a course grid surface adjacent to the fixed table rail.
